(19) United States
(12) Patent Application Publication
(10) Pub. No.: US 2026/0233475 A1
(43) Pub. Date: Aug. 13, 2026

(54) MANUFACTURING DEVICE FOR TANK

(71) Applicant: TOYOTA JIDOSHA KABUSHIKI KAISHA, Toyota-shi (JP)

(72) Inventor: Ken HATTA, Toyota-shi (JP)

(73) Assignee: TOYOTA JIDOSHA KABUSHIKI KAISHA, Toyota-shi (JP)

(21) Appl. No.: 19/391,802

(22) Filed: Nov. 17, 2025

(30) Foreign Application Priority Data
Feb. 7, 2025 (JP) 2025-019300

(51) Int. Cl. B29C 70/48; B29C 45/77; B29L 31/00

(52) U.S. Cl. CPC B29C 70/48; B29C 45/77; B29C 2945/76006; B29C 2945/7621; B29C 2945/76381; B29C 2945/76568; B29C 2945/76688; B29C 2945/76859; B29L 2031/7172

(57) ABSTRACT

A manufacturing device for a tank in which a carbon fiber layer is impregnated with resin includes: a mold; and an injection machine configured to inject the resin into the mold. The mold includes: a cavity in which a semi-finished product of the tank is placed before being impregnated with the resin; a runner extending from the injection machine to the cavity; an extrusion hole that branches from the runner and in which a colorant is placed; and an extruder slidably disposed in the extrusion hole and configured to extrude the colorant toward the runner.

### CROSS-REFERENCE TO RELATED APPLICATION

This application claims priority to Japanese Patent Application No. 2025-019300 filed on February 7, 2025. The disclosure of the above-identified application, including the specification, drawings, and claims, is incorporated by reference herein in its entirety.

### BACKGROUND

### Technical Field

The technology disclosed in the present specification relates to a manufacturing device for a tank.

### Description of Related Art

Japanese Unexamined Patent Application Publication No. 2021-167653 (JP 2021-167653 A) discloses a manufacturing device for a tank in which a carbon fiber layer is impregnated with resin. The manufacturing device includes a mold and a first injection machine that injects resin into the mold.

### SUMMARY

There is a need to color the outer surface of a tank to add design to the tank. For example, it is conceivable that a carbon fiber layer may be impregnated with resin and then the outer surface of a tank may be painted. However, painting the outer surface increases the manufacturing cost.

The present specification provides a technology for ensuring design of a tank while suppressing an increase in manufacturing cost.

The present specification discloses a manufacturing device for a tank in which a carbon fiber layer is impregnated with resin. The manufacturing device includes: a mold; and an injection machine configured to inject the resin into the mold. The mold includes: a cavity in which a semi-finished product of the tank is placed before being impregnated with the resin; a runner extending from the injection machine to the cavity; an extrusion hole that branches from the runner and in which a colorant is placed; and an extruder slidably disposed in the extrusion hole and configured to extrude the colorant toward the runner.

In the above configuration, when the resin is injected into the cavity through the runner, the colorant can be mixed with the resin flowing from the runner into the extrusion hole. Then, the resin containing the colorant is extruded toward the runner, and the colored resin is injected into the cavity through the runner. The outer surface of the tank can be colored by impregnating the carbon fiber layer with the colored resin. Since the outer surface of the tank can be colored in the step of impregnating the carbon fiber layer with the resin, there is no need for a step of painting the outer surface of the tank. It is possible to ensure design of the tank while suppressing an increase in manufacturing cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram of a manufacturing device for a tank;

FIG. 2 is a top view of a lower die;

FIG. 3 is a conceptual diagram of an extrusion hole;

FIG. 4 is a diagram showing a manufacturing method for the tank; and

FIG. 5 is a diagram showing the manufacturing method for the tank.

### DETAILED DESCRIPTION OF EMBODIMENTS

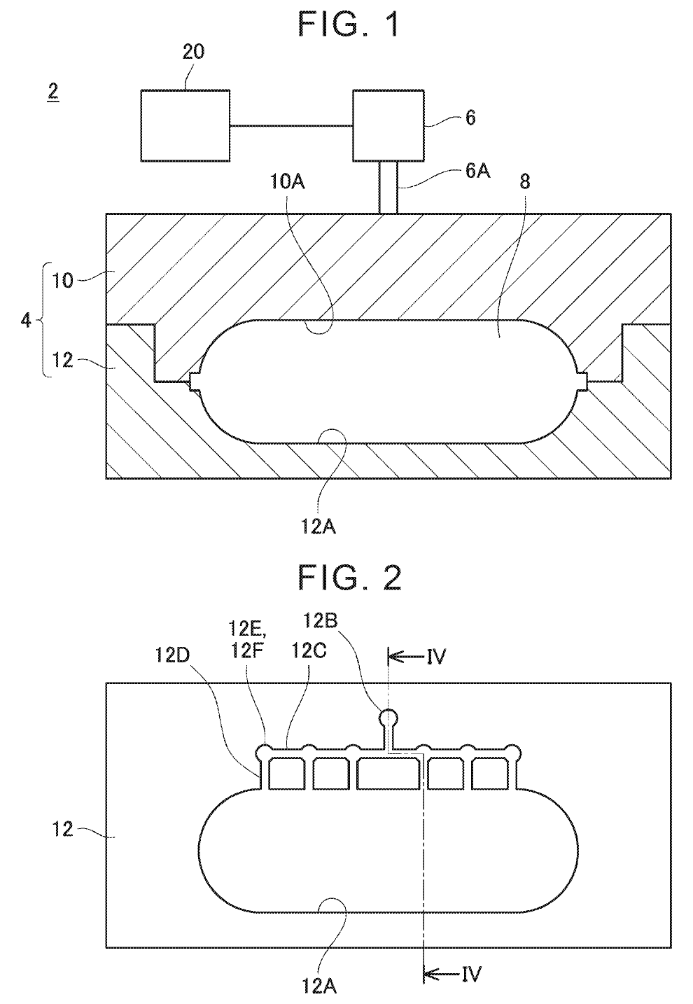

### CONFIGURATION OF MANUFACTURING DEVICE 2: FIGS 1 to 3

A manufacturing device 2 is a device for manufacturing tanks. The tank is, for example, a high-pressure tank for a fuel cell electric vehicle. The tank includes a liner that defines an interior space of the tank, and a carbon fiber layer formed on an outer surface of the liner. The carbon fiber layer is impregnated with resin by the manufacturing device 2.

The manufacturing device 2 includes a mold 4 in which a semi-finished product 8 of the tank is placed before being impregnated with resin, and an injection machine 6 that injects resin into the mold 4. The mold 4 is composed of a pair of dies 10 and 12 that sandwich the semi-finished product 8. Specifically, the mold 4 includes an upper die 10 and a lower die 12. A cavity 10A conforming to an outer shape of an upper side of the semi-finished product 8 is formed in a lower surface of the upper die 10. A cavity 12A conforming to an outer shape of a lower side of the semi-finished product 8 is formed in an upper surface of the lower die 12.

As shown in FIG. 2, a gate 12B, a main runner 12C, and a plurality of sub-runners 12D are formed in the upper surface of the lower die 12. In FIG. 2, one of the sub-runners 12D is denoted by the reference sign, and the remaining sub-runners 12D are not denoted by the reference signs.

One end of the gate 12B is connected to a channel 6A that extends from the injection machine 6 and passes through the upper die 10. The other end of the gate 12B is connected to the main runner 12C that extends along the longitudinal direction of the tank. The sub-runners 12D branch from the main runner 12C. The sub-runners 12D are connected to the cavity 12A.

The resin injected from the injection machine 6 passes over the channel 6A and the gate 12B and flows into the main runner 12C. The resin that flows into the main runner 12C flows into each of the sub-runners 12D and then flows from each of the sub-runners 12D into the cavity 12A.

Extrusion holes 12E are formed at the connection points between the main runner 12C and the sub-runners 12D. The extrusion holes 12E branch from the sub-runners 12D along the depth direction of the cavity 12A. As shown in FIG. 2, the lower die 12 has as many extrusion holes 12E as the sub-runners 12D. An extruder 12F is slidably disposed inside each of the extrusion holes 12E. The extrusion hole 12E and the extruder 12F constitute a piston. The extruder 12F is operated by an actuator such as a hydraulic actuator or a motor. The number of the extrusion holes 12E shown in FIG. 2 is merely an example. The lower die 12 may have fewer extrusion holes 12E than the sub-runners 12D or may have more extrusion holes 12E than the sub-runners 12D. In FIG. 2, one of the extrusion holes 12E and one of the extruders 12F are denoted by the reference signs, and the remaining extrusion holes 12E and the remaining extruders 12F are not denoted by the reference signs.

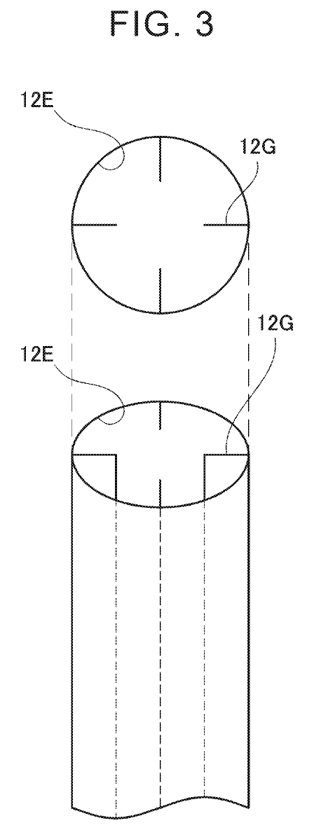

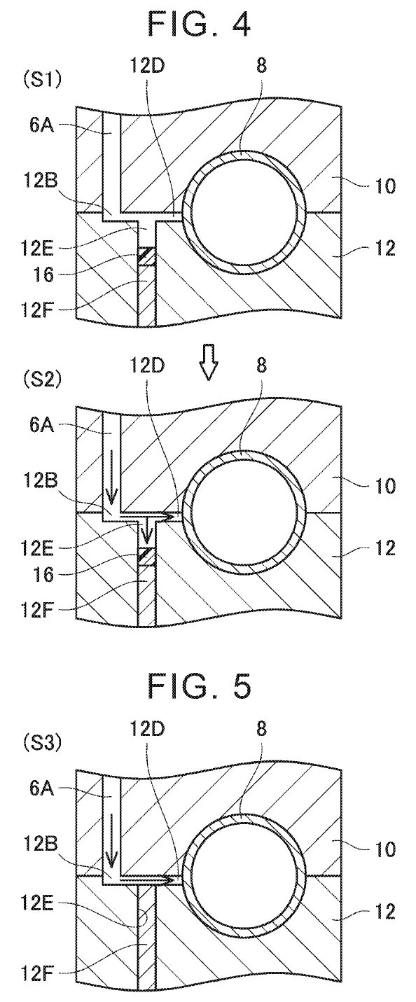

A colorant 16 (see FIG. 4) is placed inside the extrusion hole 12E. The extrusion hole 12E is configured such that the colorant 16 is mixed with the resin flowing from the sub-runner 12D. Specifically, as shown in FIG. 3, a plurality of ribs 12G for promoting mixing of the resin and the colorant 16 is formed on the inner wall of the extrusion hole 12E. Each rib 12G extends in the axial direction of the extrusion hole 12E. A pressure sensor 12H for measuring the pressure of the resin flowing through the extrusion hole 12E is disposed on the inner wall of the extrusion hole 12E. It is sufficient that the pressure sensor 12H is disposed in at least one of the extrusion holes 12E. In a modification, the pressure sensor 12H may be disposed on the inner surface of the cavity 10A or 12A. This is because the cavities 10A and 12A communicate with the extrusion hole 12E via the sub-runner 12D.

The extruder 12F has a plurality of grooves corresponding to the ribs 12G. By pushing the extruder 12F toward the sub-runner 12D, the colorant 16 in the extrusion hole 12E is mixed with the resin. By pushing the extruder 12F toward the sub-runner 12D, pressure can be applied to the resin flowing through the sub-runner 12D.

As shown in FIG. 1, the manufacturing device 2 further includes a control device 20. The control device 20 is configured to control the operations of the injection machine 6 and each extruder 12F. For example, the control device 20 controls the operation of the extruder 12F based on the pressure measured by the pressure sensor 12H in the extrusion hole 12E.

### Manufacturing Method for Tank: FIGS 4, 5

A manufacturing method for manufacturing the tank in which the carbon fiber layer is impregnated with resin will be described with reference to FIGS. 4 and 5. The manufacturing method is implemented by controlling the manufacturing device 2. FIGS. 4 and 5 are sectional views of the manufacturing device 2 taken along line IV-IV in FIG. 2.

FIG. 4 shows a placement step S1 and an injection step S2. In the placement step S1, the mold 4 is opened, and the semi-finished product 8 is placed in the cavity 12A of the lower die 12. In the placement step S1, the extruder 12F is located at a start position farthest from the sub-runner 12D. In the placement step S1, the colorant 16 is placed in each of the extrusion holes 12E. When the colorant 16 is placed in the extrusion hole 12E, the upper die 10 is pressed against the lower die 12, that is, die clamping is performed. Then, degassing is performed to bring the cavities 10A and 12A of the mold 4 into a state close to a vacuum. In each of the drawings, a device that performs degassing is omitted from illustration.

After the placement step S1, the injection step S2 is performed. In the injection step S2, the control device 20 transmits a command to the injection machine 6 to start injecting resin into the mold 4. Thus, the injection machine 6 starts injecting the resin. The resin is injected into the cavities 10A and 12A through the channel 6A, the gate 12B, the main runner 12C, and the sub-runners 12D. In the injection step S2, part of the resin flowing through the main runner 12C and the sub-runner 12D flows into each extrusion hole 12E.

FIG. 5 shows an extrusion step S3 that is performed after the injection step S2. The control device 20 performs the extrusion step S3 when the pressure measured by the pressure sensor 12H exceeds a predetermined value. The extrusion step S3 includes a first extrusion step and a second extrusion step. In the first extrusion step, the control device 20 moves the extruder 12F from the start position to a predetermined intermediate position toward the sub-runner 12D. Thus, the colorant 16 placed in the extrusion hole 12E in the placement step S1 and the resin that has flowed into the extrusion hole 12E in the injection step S2 are mixed together. In particular, the ribs 12G promote mixing of the colorant 16 and the resin. When the control device 20 moves the extruder 12F to the intermediate position, the control device 20 temporarily stops the extruder 12F at the intermediate position. For example, the extruder 12F is stopped at the intermediate position until the colorant 16 is sufficiently dispersed into the resin.

In the second extrusion step, after a predetermined time has elapsed since the extruder 12F moved to the intermediate position, the control device 20 moves the extruder 12F from the intermediate position to an end position toward the sub-runner 12D. Thus, the resin colored by the colorant 16 is injected into the cavities 10A and 12A through the sub-runner 12D. The extruder 12F applies additional pressure to the resin injected into the cavities 10A and 12A.

### Effects of Present Embodiment

In the configuration of the present embodiment, when the resin is injected into the cavities 10A and 12A through the sub-runner 12D, the colorant 16 can be mixed with the resin flowing from the sub-runner 12D into the extrusion hole 12E. Then, the resin containing the colorant 16 is extruded toward the sub-runner 12D, and the colored resin is injected into the cavities 10A and 12A through the sub-runner 12D. The outer surface of the tank can be colored by impregnating the carbon fiber layer with the colored resin. Since the outer surface of the tank can be colored in the step of impregnating the carbon fiber layer with the resin, there is no need for a step of painting the outer surface of the tank. It is possible to ensure design of the tank while suppressing an increase in manufacturing cost. Further, tanks in various colors can be manufactured simply by changing the color of the colorant 16 to be placed in the extrusion hole 12E.

### Correspondence

The manufacturing device 2, the mold 4, and the injection machine 6 are examples of a "manufacturing device," a "mold," and an "injection machine," respectively. The semi-finished product 8 and the control device 20 are examples of a "semi-finished product" and a "control device," respectively. The cavities 10A and 12A are examples of a "cavity." The sub-runner 12D, the extrusion hole 12E, and the extruder 12F are examples of a "runner," an "extrusion hole," and an "extruder," respectively. The rib 12G and the pressure sensor 12H are examples of a "rib" and a "pressure sensor," respectively.

Notes on the technology set forth in the embodiment will be described below. The number of the ribs 12G is not limited to four as shown in FIG. 3, but may be one, two, three, five, or more. The ribs 12G in FIG. 3 are merely one example of the configuration for promoting mixing of the colorant 16 and the resin. The ribs 12G may be omitted from the extrusion hole 12E.

What is claimed is:

1. A manufacturing device for a tank in which a carbon fiber layer is impregnated with resin, the manufacturing device comprising:
a mold; and
an injection machine configured to inject the resin into the mold, wherein
the mold includes:
a cavity in which a semi-finished product of the tank is placed before being impregnated with the resin;
a runner extending from the injection machine to the cavity;
an extrusion hole that branches from the runner and in which a colorant is placed; and
an extruder slidably disposed in the extrusion hole and configured to extrude the colorant toward the runner.

2. The manufacturing device according to claim 1, wherein the extrusion hole is configured such that the colorant is mixed with the resin flowing from the runner.

3. The manufacturing device according to claim 2, wherein a rib configured to promote mixing of the resin and the colorant is provided on an inner wall of the extrusion hole.

4. The manufacturing device according to claim 3, wherein a plurality of the ribs extending in an axial direction of the extrusion hole is provided on the inner wall.

5. The manufacturing device according to claim 1, further comprising:
a pressure sensor configured to measure pressure of the resin flowing through the extrusion hole; and
a control device configured to control an operation of the extruder based on the pressure measured by the pressure sensor, wherein
the control device is configured to perform:
a process of moving the extruder from a start position to a predetermined intermediate position toward the runner when the pressure measured by the pressure sensor exceeds a predetermined value after the injection machine has started injecting the resin; and
a process of moving the extruder from the intermediate position to an end position toward the runner after the extruder has been temporarily stopped at the intermediate position.
